(19) United States
(12) Patent Application Publication
(10) Pub. No.: US 2005/0117963 A1
(43) Pub. Date: Jun. 2, 2005

(54) Accessible file system

(76) Inventor: Douglas James Metcalf Hall, Phoenix, AZ (US)

Correspondence Address: TOD R. NISSLE, P.C., P.O. Box 55630, Phoenix, AZ, 85078, US

(21) Appl. No.: 10/941,754

(22) Filed: Sep. 15, 2004

Related U.S. Application Data
(60) Provisional application No. 60/503,275, filed on Sep. 16, 2003.

(51) Int. Cl. B42F 3/00

(52) U.S. Cl. 402/60

(57) ABSTRACT

A file system is provided. This system includes a folder and a pair of spaced apart prongs mounted on the folder. An auxiliary member is mount on the prongs. A pair of a transfer legs is mounted on the auxiliary member.

### FIELD OF INVENTION

The present invention relates to accessible file systems also known as transfer files for storing in a file folder from one to a stack of marginally perforated sheets (usually documents recorded on paper) in a manner allowing individual sheets or parts of the stack to be readily accessed and optionally removed or interchanged with other sheets in a replaceable manner or to be reinserted into different positions within the stack or moved from one file to another.

### BACKGROUND OF THE INVENTION

Various such systems are known and referred to by various names including ring binders, lever arch files, ring clip files, spring sort files and other names.

Different systems differ considerably in price, adaptability to different purposes and various advantages and drawbacks.

A need still exists for an improved system which can be manufactured at reasonable cost yet can be adapted to a large variety of uses, including ready adaptation to some widely used existing filing systems in order to render these more functional and user friendly.

General Description of the Invention

The accessible file system according to the invention is of the type set out under “Field of the Invention” and more specifically of the type comprising a bottom flap and hinged thereto a top flap, these flaps being so interrelated that the stack of perforated sheets can be contained there between, fitted to the bottom flap a plurality of flexible bottom prongs spaced and positioned to match perforations of the perforated sheets, a transfer mechanism connected to the top flap including top prongs movable in relation to the top flap between being folded away there against and standing proud thereof with a spacing matching the spacing of the bottom prongs, the bottom prongs and top prongs having ends adapted for the bottom prongs to be connected to the top prongs end to end, preferably to be plugged together, preferably in male/female relationship and an elongate compression bar having aperture means for accommodating in spaced apart relationship the bottom prongs and having holding down means which when the bottom prongs are disengaged from the top prongs can be brought into engagement with and hold, folded down, the bottom prongs to compressively, at the margin, hold down the stack of marginally perforated sheets.

The invention now provides a number of improvements.

According to one aspect of the invention the bottom prongs are resiliently flexible which implies a degree of rigidity and a restoration capacity enabling the prongs when released from their folded down position to straighten out of their own account and stand upright and proud of the bottom flap. Suitable materials for the prongs are coil springs, as have been used in certain earlier systems with which the applicant has experimented. Such coil springs, being hollow, provide automatically at their ends the female socket counterpart for the male ends of the top prongs to be plugged in, if these top prongs are, for example, made of metal wire.

However, alternatively these bottom prongs may be made of elastomer tubes or rods having sufficient restoring power to straighten out and stand proud when released from their folded down positions. Again, if the bottom prongs are made of an elastomer material in tubular form, this automatically provides bottom prongs having ends which serve as female socket counterparts into which the male ends of the top prongs may be plugged.

Applicant has experimented with a prior attempt using highly flexible plastics tubular bottom prongs, lacking the aforesaid restoring power, in combination with a loose U-shaped transfer device of plastics, the legs of which form prongs which are plugged into ends of the flexible bottom prongs. These highly flexible tubular bottom prongs can only be brought into engagement with and held folded down by the substantially non-yielding holding down means of the elongate compressor bar if the flexible tubular prongs are pinched flat in order to be squeezed underneath the lug-shaped holding down means of the compressor bar. This requires rather awkward manipulations of the bottom prongs. Once these bottom prongs have been released from the holding down means, the prongs, because of their high degree of flexibility and lack of restoring power flop down loosely, and for this reason insertion of the prongs into the marginal perforations of perforated sheets to be filed likewise is awkward. The applicant's reference to this prior attempt is not to be construed as an admission of prior art in law but is merely made to better explain distinguishing features of the invention.

The elongate compressor bar, according to the preferred embodiments, is substantially rigid and may be made of metal, more particularly pressed sheet metal, or plastics. In either case the compressor bar is preferably profiled for increased rigidity, which can include reinforcing ridges at its center and/or edges. In the case of plastics it is preferred for such plastics to be molded to a profile as known from commercially available plastics rulers. Such profile basically comprises a flat underside, two parallel, relatively thin straight edges defining the longitudinal outlines and two shallowly inclined top surfaces rising from each of the said edges towards an imaginary top central apex, preferably stopping short thereof either to form a flat top surface or intermittent depressions, more particularly, elongate depressions to reduce weight and material consumption. In addition or alternatively, such depressions may be provided in the otherwise flat underside surface. As in conventional rulers the inclined top surfaces may carry length measuring markings according to standard units of length, e.g. mm and/or cm and/or inches and fractions thereof.

The compression bar has apertures through which the bottom prongs may pass. This may take the form of simple preferably round holes spaced in accordance with standard spacings of the marginally perforated sheets to be filed. Alternatively, the apertures may be elongate in the longitudinal direction of the compression bar.

The invention proposes, for example, three-hole left margin, two-hole left margin as well as two-hole top margin embodiments, preferably to be compatible with conventional marginal perforation systems. Any other suitable standard or non-standard arrangement may be adopted.

The arrangement of the holding down means on the compression bar determines the direction in which the bottom prongs are held when folded down. If these holding down means hold these prongs folded longitudinally away from one another, this may limit the lengths of the bottom prongs that can be accommodated within the confinements of the file cover when closed, particularly for as long as few or no papers are in the file. This in turn may limit the thickness of the stack of sheets which can be filed.

These limitations may be improved upon in accordance with the invention by the holding down means being so positioned and arranged as to hold the bottom prongs folded down longitudinally towards one another and past one another, parallel to one another side by side. In the case of three-hole left margin embodiments the center bottom prong and one of the outer bottom prongs will be so held down and the third bottom prong will be held folded down longitudinally towards the central bottom prong.

Even more preferred are embodiments, wherein the holding down means are so positioned and arranged as to hold the bottom prongs folded down transversely to, i.e. usually normal to the longitudinal dimension of the compression bar, away from the perforated sheet margin. With this embodiment the length of the prongs is limited only by the dimensions of the sheets and the corresponding dimensions of the file.

Various designs of the holding down means are possible, e.g. clips of various kinds requiring no description. However, for the sake of simplicity and ease of manufacture these means preferably take the form of lugs protruding from the top of the compression bar, adjoining the respective apertures for accommodating the bottom prongs in the direction in which the respective bottom prongs are to be folded and held down and providing an open-ended gap between the top of the compression bar and the underside of each lug, dimensioned to accommodate the thickness of the bottom prong. In order to inhibit inadvertent slipping out of the bottom prong from underneath the lug a catch formation is preferably provided on said underside. Alternatively, each aperture is adjoined by a pair of mutually adjoining lugs protruding from the top of the compression bar, the two lugs providing open-ended gaps between the underside of each lug and the top of the compression bar, staggered in relation to the position of the bottom prong and adapted for the open-ended gaps to receive the bottom prong from opposite sides. In that case the spring action of the prong keeps the prong firmly in place.

Usually the flexible bottom prongs are fitted to the bottom flap by way of a “Z”-folded gusset in the bottom flap. This gusset is preferably fixed down against the bottom flap proper, e.g. by stapling, riveting or adhesive bonding, after the bottom prongs have been fitted thereto.

The transfer mechanism preferably comprises a base plate, e.g. a pressed strip of sheet metal or molded plastic and a top prong member, preferably made of wire, including a support bar from which the top prongs project and which preferably also serves as a hinge pin about which the prong member is hinged to the base plate which in its turn is affixed to the top flap in any suitable manner, e.g. by riveting or adhesive bonding.

In the case of two-holed embodiments the top prong member is preferably a piece of wire bent essentially into a U-shape, the two legs of which form the top prongs. The top prong member is preferably designed to be resiliently biased when in the folded down position, to be retained in that position and also to be restrained, e.g. frictionally against falling over e.g. to a folded down position, once the prongs have been swung into a generally upward position. This can be achieved in a variety of manners, although a particularly simple manner is by deformation of the base of the “U” constituting the support bar and hinge pin, so as to create a bulge which frictionally with a spring action engages and presses against the top of the base plate when the prongs are upright and releases its pressure on the base plate only when the prongs are folded down. Alternatively, or in addition, the base plate can include one or more bulges against which the base of the “U” will frictionally engage.

In the case of the three-hole left side margin embodiments, the arrangement may be the same, in principle, (apart from dimensional adaptations), save that a third, central top prong is affixed in any suitable manner to the base of the “U” halfway between the legs of the “U” constituting the remaining two top prongs. Such affixing of the central top prong may e.g. be brought about by welding or soldering. Optionally the base of the “U” may include kinks which coact with the hinge members to prevent lateral movement of the prongs.

In the event of two-hole top margin embodiments, several modifications are available. Common to all is the need for a bottom flap to which the bottom prongs are fixed and, hinged to the bottom flap, about a hinge line parallel to the position of the perforated top margins of sheets to be filed, a top flap to which is fixed the transfer mechanism. The bottom and top flaps may together constitute the outer cover of the file.

Alternatively the top flap carrying the transfer mechanism is formed by a flap member hinged to the top marginal region of the bottom outer cover member in addition to there being provided a top outer cover member proper hingedly connected to the left side marginal region of the bottom outer cover member. All three aforesaid flap members can be cut integrally from a single sheet of heavy duty paper or plastic. In addition to this, either or both of the remaining marginal regions of the bottom flap member (i.e. the side and bottom marginal regions) may have flaps hingedly connected thereto, serving for more complete enclosure and protection of the file contents.

As a further alternative, existing conventional filing systems may be converted into an accessible file system in accordance with the invention. Mainly for this purpose a mini-version of the invention may be used. In that embodiment of the two-prong top margin version of the invention the top and bottom flaps respectively holding the bottom prongs and the transfer mechanism may be substantially smaller than the outlines of the top and bottom cover flaps of the file cover proper. Such a mini-file can then be fitted and suitably affixed by any means inside any standard available file cover to convert it to the system according to the invention.

The bottom flap of the mini-file may, for example, be affixed to the bottom outer cover of the file cover proper by stapling, riveting or adhesive action. If the file cover proper, or partitions within the file cover proper are equipped with prongs for filing marginally perforated sheets, e.g. of the two-hole top margin type, the top area of the bottom flap member of the mini-file may be similarly perforated and fixed to the file cover proper or to any partitions within said file cover proper, by inserting the prongs of the file cover proper or partitions through the said perforations of the mini-file and folding the prongs over in the conventional manner.

It will be understood by those skilled in the art that the principles of a mini-file for two-hole top margin perforations can be adapted in an analogous fashion to two-hole or three-hole left margin perforations.

### BRIEF DESCRIPTION OF THE DRAWINGS

FIG. 1 represents a perspective view, partly exploded and partly broken away of one embodiment of an accessible file system according to the invention;

FIG. 2 shows an elevation of a bottom prong as used in FIG. 1;

FIG. 3 represents a plan view of the base plate of the transfer mechanism in FIG. 1;

FIG. 4 shows in side elevation the hinge of the base plate in FIG. 3;

FIG. 5 shows in opened up plan view, partly broken away and on a larger scale the system shown in FIG. 1;

FIG. 6 shows in plan view the compression bar alone of FIG. 5;

FIG. 7 shows alone a U-shaped top prong member in plan view for a 2-hole system;

FIG. 8 shows a view similar to FIG. 7 of a top prong member for a three-hole system as in FIG. 5;

FIG. 9 shows a view similar to FIG. 5 of an embodiment using an alternative compression bar;

FIG. 10 shows a plan view of the compression bar in FIG. 9;

FIG. 11 shows a cross-section of the compression bar in FIG. 10;

FIG. 12 shows on a larger scale a side elevation of a holding down means of a compression bar as shown in FIGS. 9 and 10;

FIG. 13 shows a view similar to FIG. 10 of a modified embodiment of the compression bar;

FIG. 14 represents a mini-file type of embodiment according to the invention in a view similar to FIGS. 5 and 9 and

FIG. 15 shows an alternative form of compression bar suitable for a two-hole system.

### DETAILED DESCRIPTION OF SPECIFIC EMBODIMENTS

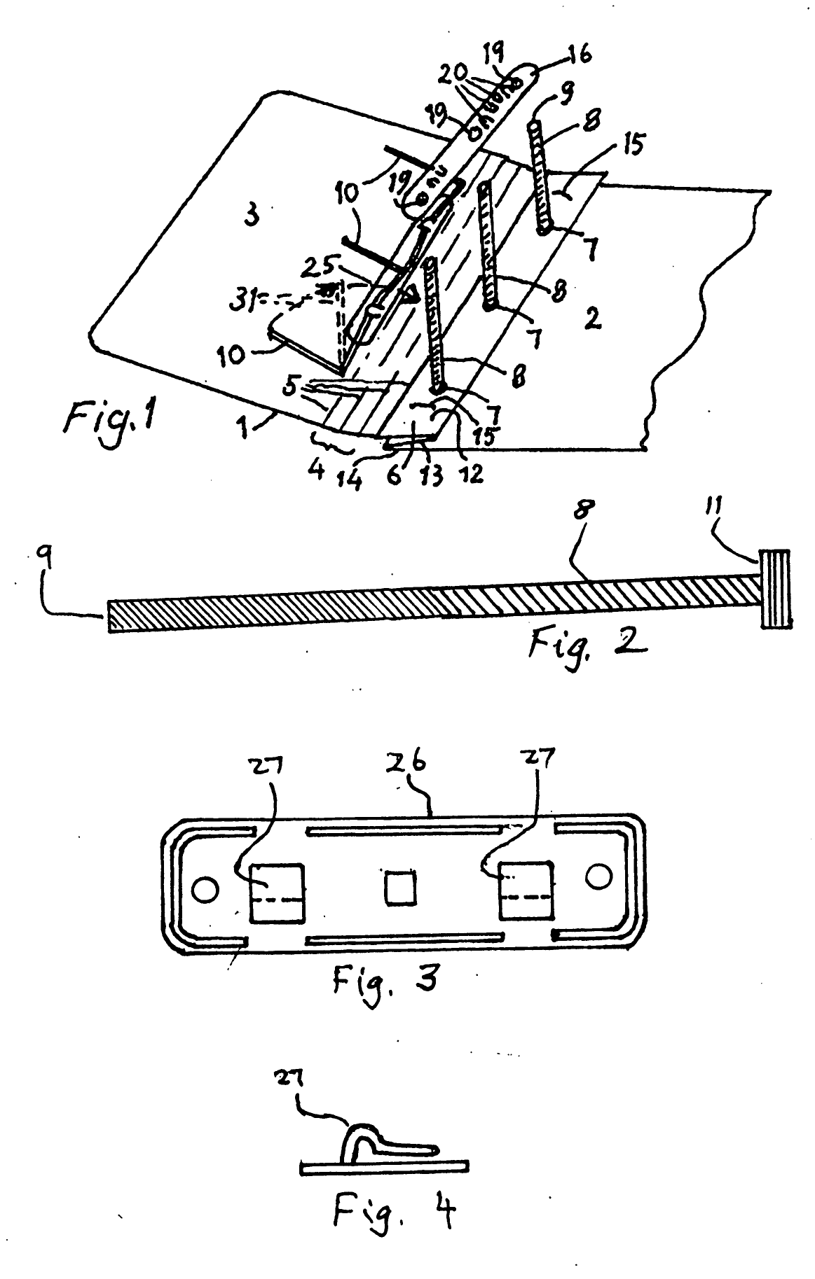

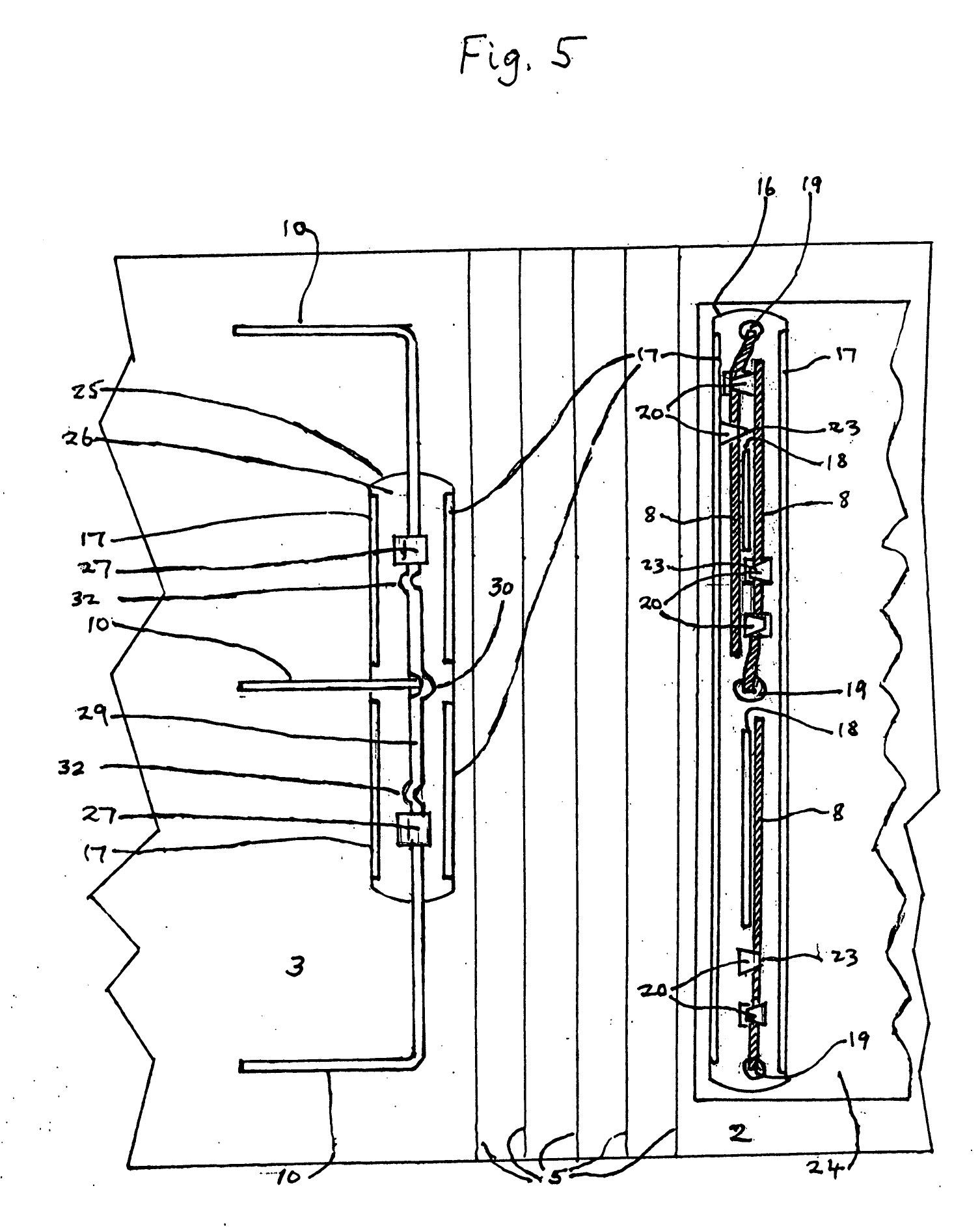

Referring first to FIGS. 1 to 8 and in particular FIG. 1, a file cover 1 is shown comprising a bottom flap 2 and a top flap 3 connected by a hinge region 4 with a plurality of fold lines 5. Between the hinge region 4 and the bottom flap 2 the sheet material of the file cover is folded in Z-shaped fashion to form a gusset 6 the upper transverse limb 12 and connecting web 13 of which have three perforations 7 through which project three bottom prongs 8. The spacing of apertures 7 corresponds to standard left margin three-hole perforations for the sheets (e.g. document pages) to be filed. As can be seen in FIG. 1, the bottom prongs 8 have sufficient restoring power when released to stand proud of the bottom flap, substantially normal thereto, without any other support.

Details of the bottom prongs 8 are shown on a larger scale in FIG. 2. Each prong is composed of a length of resiliently flexible coil material e.g. spring having one open end 9 serving as a socket for receiving the matching male end of a top prong 10. The opposite end of the bottom prong is formed by a flat head 11 which prevents the prong from leaving the hole 7. In the final assembly the head 11 becomes sandwiched between bottom flap 2 and connecting web 13, or alternatively sandwiched between connecting web 13 and upper transverse limb 12. Limb 14 is formed by the left hand margin of the bottom flap 2. The gusset may be kept closed by staples 15 or rivets. Alternatively or in addition, the webs and limbs of the gusset may be (wholly or in parts) laminated together by an adhesive. It is possible for the head 11 of each bottom prong to be adhesively bonded or alternatively affixed to the underside of the connecting web 13. Optionally the Z-gusset may be eliminated entirely, e.g. by perforating the holes through the bottom flap, inserting the bottom prongs from the underside of the bottom flap and using a strong (e.g. nylon reinforced) adhesive tape over the flattened bottoms of the prongs to retain them to the outside of the bottom flap.

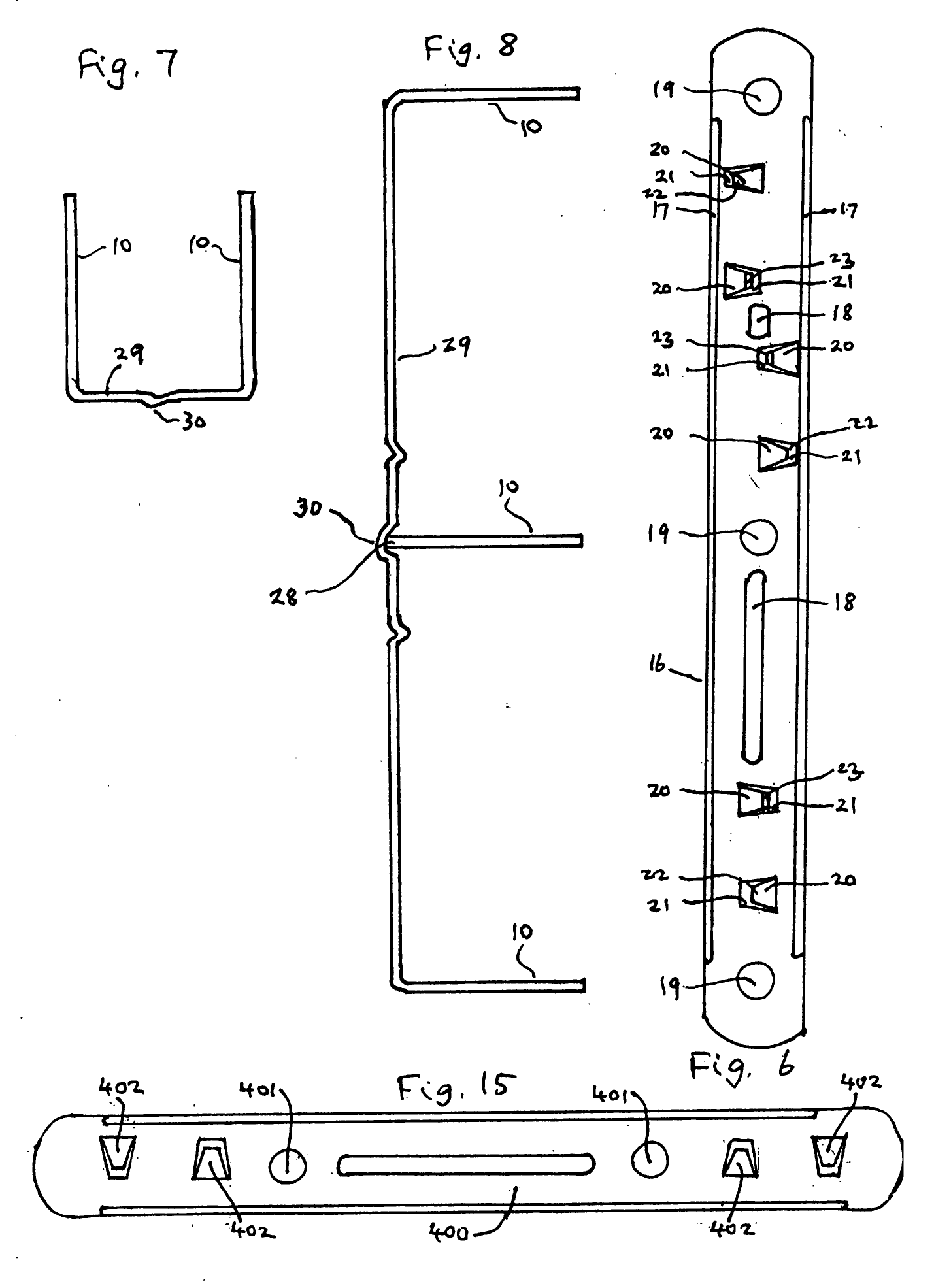

The compression plate 16 may (as shown in FIGS. 5 and 6) be a sheet metal pressing carrying for improved rigidity marginal ridges 17 and optionally central longitudinal ridges 18 and provided with three apertures 19, through which the bottom prongs 8 may pass. In addition, holding down members for the bottom prongs are provided in the present instance, pairs of lugs 20 adjoining each aperture 19 in the longitudinal direction of the compression bar 16. The side on which these lugs are provided in relation to the hole determines the direction in which the bottom prongs 8 are bent and held down. Each lug of a pair provides a gap 21 (also depicted as 106 in FIG. 12), open-ended towards one side, dimensioned to accommodate the thickness of the down folded bottom prong 8 held between the underside of the lug and the upper surface of the compression bar without any appreciable squeezing of the prong. The open ends of each gap are formed by the tip 22 of each lug. The lugs of a pair face in opposite directions and are designed to embrace the bottom prong 8 in its down folded state. They are offset in relation to one another viewed in the direction of the down folded bottom prong 8. A single lug can be used instead of a pair if the underside of the lug is provided with a catch formation 23 to restrain the prong against slipping out of the gap 21. Even when using pairs of lugs as in FIGS. 5 and 6, it is preferred for the lug furthest removed from the respective aperture 19 to have such a catch formation 23 (FIG. 6) and 107 (FIG. 12).

FIG. 5 shows how with the arrangement of lugs according to FIGS. 5 and 6 it is possible to accommodate in a folded down position much larger bottom prongs 8 than if the lugs were arranged for these prongs to be held down in a longitudinally outward facing direction (as will be described later with reference to FIG. 15). In the case of left margin three-hole embodiments that would necessitate drastic shortening of the prongs and, therefore, of the thickness of stacks of sheets 24 which can be accommodated in the file.

As will be seen in FIG. 5, the bottom prongs passing through the apertures 19 which in the drawing are uppermost and central are folded down longitudinally in respect of the compression bar towards and past one another, i.e. parallel to one another side by side on opposite sides of the upper central stiffening ridge 18 (FIG. 6). The prong 8 which in FIG. 5 is lowermost, is folded and held down towards the central bottom prong.

The transfer mechanism is generally denoted as 25. It comprises a base plate 26 affixed to the top flap 3 adhesively or by rivets or other fasteners and has hinges 27 for the hinged connection to the base plate of the top prongs 10, three in number in the embodiment of FIGS. 1 to 6 and 8. The base plate in the example shown is pressed from a sheet metal strip and has peripheral ridge formations 17 for increased rigidity.

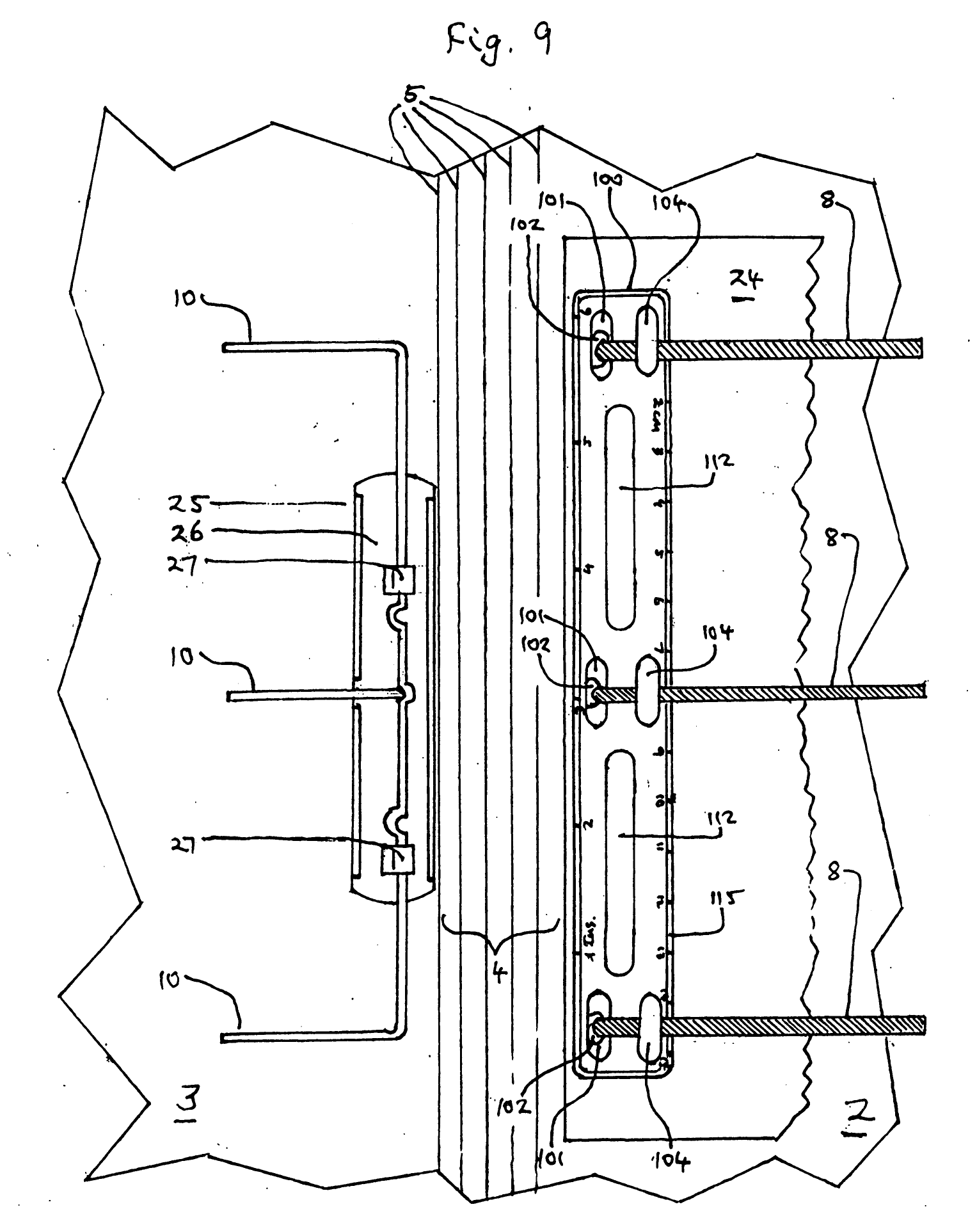

As shown particularly in FIG. 8 the outermost top prongs 10 form the upright legs of a U-shaped top prong member bent from wire, the base of the “U” forming a hinge pin 29 held by the hinge members 27 in pivotal relationship. The third (middle) top prong 10 is welded at 28 to the hinge pin 29. The central region 30 of the hinge pin 29 forms a bulge which co-acts with the upper surface of the base plate 26 to resiliently bias the top prong member to lie flat against the top flap 3 when folded down (FIG. 5). Bulges 32 are formed in hinge pin 29 close to hinge members 27 to prevent lateral movement of hinge pin 29. The top prong member can be swung into a generally upward position (broken lines 31 in FIG. 1). In that position the bulge region 30 presses down onto the base plate with sufficient force to frictionally hold the prongs 10 in a generally upward position, ready to be plugged into the open ends 9 of the hollow bottom prongs when these are bent over in an arcuate fashion to receive the tips of the top prongs 10. Compression bar 16 and any papers or other sheets (not shown in FIG. 1) stored in the file may now be moved over, sliding on the arches formed by the connected top and bottom prongs from the right hand to the left hand side to the extent needed to render accessible that part of the file where changes of contents need to be made, by removing, adding or interchanging sheets. Opening and closing of the arches takes place by unplugging and re-plugging the ends of the top and bottom prongs for removing or adding sheets. The principle is similar to conventional ring binders. This convenient way of moving filed sheets from one side of the file to the other also greatly facilitates reading documents in the lower parts of a stack of sheets.

Referring now to FIG. 9 to 13, the arrangement is essentially similar to the embodiments described above, except that certain design modifications have been made to the compression bar. Identical parts are again denoted by the same reference numbers as above.

It should be noted that some of the modifications described in what follows can be applied to compression bars made of metal or plastics in a manner requiring no description.

One such modification is that the round apertures 19 in FIGS. 5 and 6 have been replaced by longitudinally elongated slots 101. This permits greater adaptability to different spacings of the bottom prongs 8 and the marginal perforations 102 of sheets to be filed. These slots 101 are not on the longitudinal center line as in the previous embodiments, but are instead offset towards one longitudinal edge 103. Next to each aperture an open-ended lug-like clip 104, the details of which are shown in FIG. 12, is provided adjoining the opposite longitudinal edge 105. These clips 104 are open-ended at 106, where the underside carries a retaining nose 107 for retaining the bottom prong 8 after having been inserted through the open end 106. As shown in FIG. 9, this arrangement causes the down folded bottom prongs 8 to be held at right angles, transversely to the elongation of the compression bar 100. This feature allows for the comfortable accommodation within the confines of the file cover of very long bottom prongs 8, whereby the holding capacity of the file is increased accordingly.

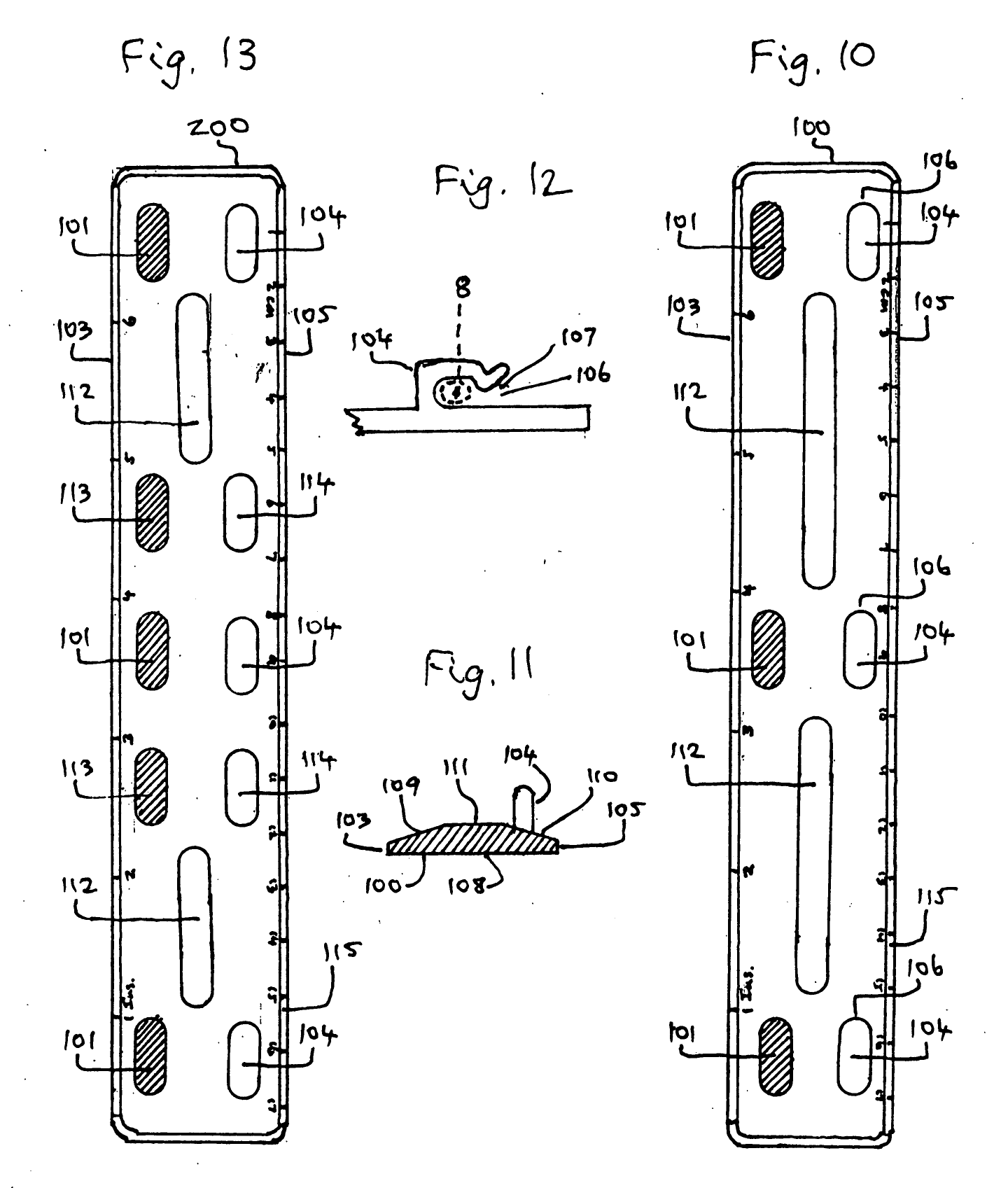

For increased rigidity the compression bar has a molded ruler-like profile as shown in cross-section in FIG. 11, comprising a flat underside 108 bordered by relatively thin straight longitudinal edges 103, 105 from where rise two shallowly inclined top surfaces 109, 110 towards and stopping short of an imaginary top central apex to form a flat top surface 111 parallel to the underside 108. For increased rigidity marginal ridges 115 are included. For weight and material saving longitudinal depressions 112 are optionally formed into the top surface.

For added convenience the compression bar 100 is usable as a ruler and measuring stick by carrying measuring markings graduated in mm and/or cm along one edge 103 or 105 and in inches and fractions thereof along the opposite edge 105 or 103.

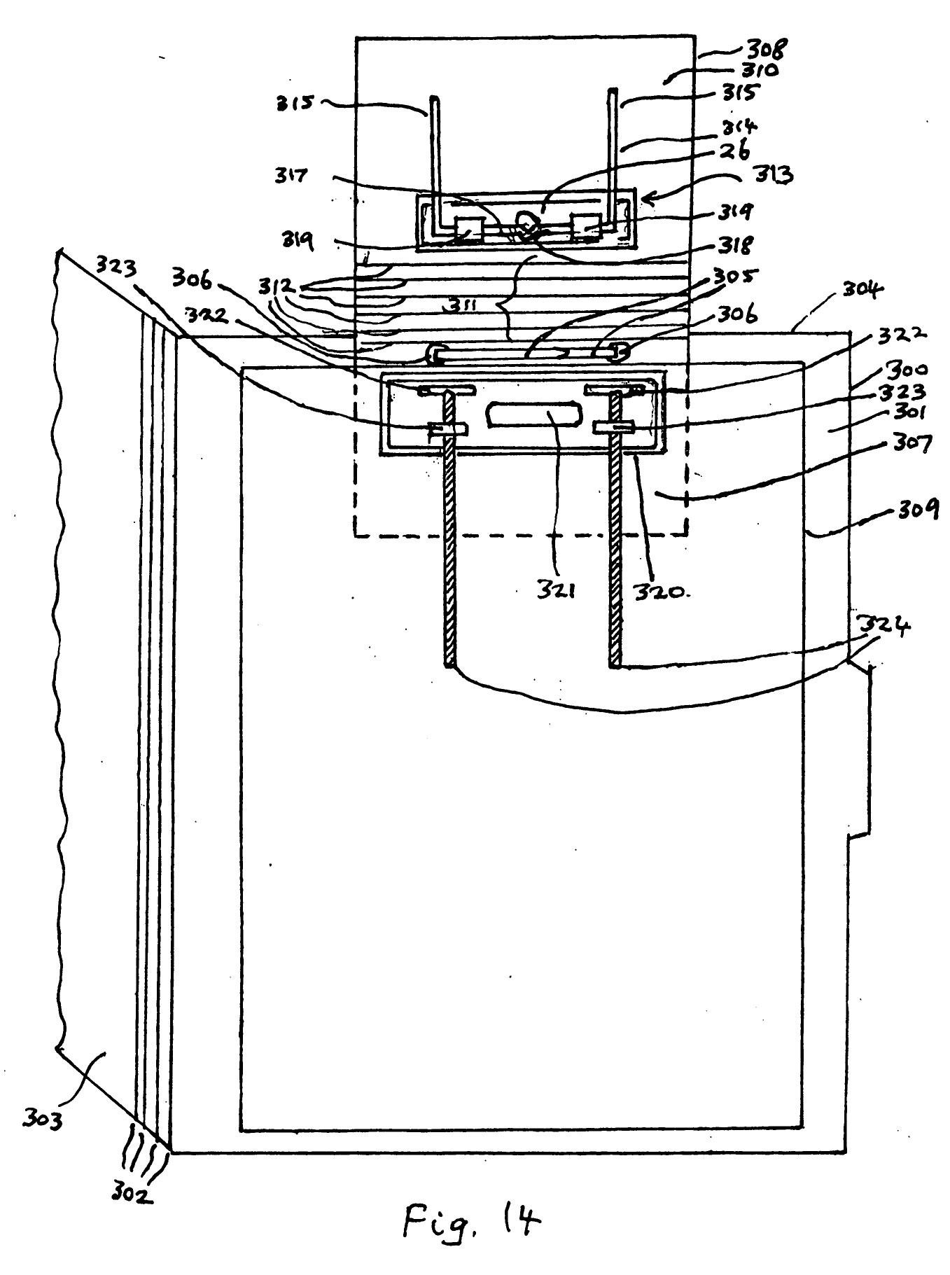

FIG. 13 shows a modified compression bar 200 to compression bar 100 in FIG. 10. It differs by the provision of two pairs of slots 113 and clips 114 in addition to slots 101 and clips 104. In this manner, the compression bar 200 can be used for three-hole left margin as well as two-hole left margin systems, e.g. an embodiment similar to that shown in FIG. 1 except having two bottom prongs 8 instead of three, and a “U” shaped double prong as shown in FIG. 7 instead of the three prongs as shown in FIG. 8.

In accordance with FIG. 14 a main file cover 300 is provided comprising a bottom flap 301 hinged by way of folding lines 302 to a top flap 303. The bottom flap is equipped near its top margin 304 with conventional flat strip metal prong devices including two foldable flat strip metal prongs 305. These prongs 305 pass through a pair of perforations 306 through the top area of the bottom flap 307 of a “mini-file” generally indicated as 308. The prongs 305 are folded over to hold the mini-file 308 in place.

The mini-file 308 is basically constructed like the previously described embodiments, except that it is designed for filing papers, documents or like sheets that have been perforated with two holes at the top margin, a stack of filed papers, documents or like sheets 309 being shown. The mini-file serves to be used inside a conventional file cover 300 to which has been affixed conventional flat strip metal prong device including two foldable flat strip metal prongs 305, to convert conventional file cover 300 to the system in accordance with the invention. What is described in the following applies equally to full size two-hole top margin accessible file systems except that top flap 310 and bottom flap 307 connected by the hinge region 311 with folding lines 312 have full-size file cover dimensions.

The transfer mechanism 313 is fitted to the top flap 310 as described for the previous embodiments and is of essentially the same design. The base plate 26 is identical to the base plate in FIGS. 1, 3, 5 and 8 to 9. Instead of a three-pronged top prong member (FIG. 8) a U-shaped two-pronged top prong member 314 is used similar to that shown in FIG. 7, including a slight kink 318 where it connects to the hinge pin portion 317.

The compression bar 320 is profiled as shown in FIG. 11 with an elongate depression 321. It has only two circular or slot-shaped apertures 322 and adjoining lug-shaped clips 323 identical to the two apertures 113 and clips 114 in FIG. 13.

FIG. 15 depicts an alternative embodiment of a compression bar 400 pressed from strip metal like the compression bar 16 described with reference to FIGS. 5 and 6, or made in plastics. It has apertures 401 for accommodating the bottom prongs 324 (FIG. 14). It would be possible to provide pairs of lugs associated with each aperture 401 arranged as in the upper half of FIG. 5 so that the prongs can be folded longitudinally in respect of the bar towards and past one another. It would be possible to have slots 322 as depicted in FIG. 14 instead of circular holes 401. It would be possible to have lug-like clips 104 as depicted in FIG. 12 instead of pairs of lugs 402.

In the embodiment of FIG. 15 the prongs 324 (FIG. 14) must be folded over along the length axis of the compression bar 400 directed outwardly. Although this works well for an embodiment of FIG. 1 with two bottom prongs 8 and the double prong as depicted in FIG. 7, when used for sheets 309 that have been perforated with two holes at the top margin as depicted in FIG. 14 it limits the lengths of the prongs 324.

What has been described in the foregoing can be modified or realized in a number of different combinations as will be understood by those skilled in the art.

1. A file system including
a. a folder;
b. b at least a pair of spaced apart prongs mounted on said folder;
c. an auxiliary member mounted on said prongs; and
d. at least of a pair of transfer legs mounted on said auxiliary member.
